(19) United States
(12) Patent Application Publication
(10) Pub. No.: US 2010/0118091 A1
(43) Pub. Date: May 13, 2010

(54) ENHANCED TRACES OF FLEXIBLE TAB CIRCUIT FOR ATTACHMENT ON BOND PADS OF INKJET PRINTHEAD CHIP IN PRINTHEAD CARTRIDGE ASSEMBLY

(76) Inventors: Girish Shivaji Patil, Lexington, KY (US); Salvatore Alexander Ruggero, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/269,935

(22) Filed: Nov. 13, 2008

(51) Int. Cl. B41J 2/14

(52) U.S. Cl. 347/50

(57) ABSTRACT

An enhanced electrically-conductive trace on a flexible TAB circuit includes a main body section and an end section integrally connected with and extending from the main body section in a predetermined first direction. The main body section is supported on a substrate. The end section extends from the main body section past an edge of the substrate. The end section has an end portion attachable on a bond pad of an inkjet printhead chip and an interconnect portion spanning between the main body section and the end portion of the end section. The end portion has a predetermined width greater than that of the interconnect portion as measured in a second direction transverse to the predetermined first direction. The trace end portion may have different shapes, for example, square, circular and diamond as well as other shapes.

### BACKGROUND

1. Field of the Invention

The present invention relates generally to flexible tape automated bonding (TAB) circuits used in inkjet printers and, more particularly, to enhanced traces on a flexible TAB circuit for attachment on bond pads of an inkjet printhead chip in a printhead assembly.

2. Description of the Related Art

Typically, an inkjet printer cartridge assembly includes an ink-filled polymeric container, an inkjet printhead chip adhesively secured to the container, and a flexible TAB circuit attached to the container. The printhead chip is mounted to the container through and within a window on the TAB circuit. The TAB circuit has a substrate, for example made of polyimide, and multiple electrical contact pads at one end of the substrate for connecting to corresponding contacts in the inkjet printer. The TAB circuit also has multiple closely-spaced electrically-conductive traces, for example made of metal, formed on a bottom side of the substrate that connect the printhead chip to the contact pads. The trace pattern is created with a photolithography process. The metal traces are either electroplated on the polyimide substrate or a thin sheet of metal is attached to the polyimide substrate with adhesive.

As illustrated and described in U.S. Pat. No. 5,953,032, assigned to the assignee of the present invention and the disclosure of which patent is hereby incorporated herein by reference, the traces have main body sections and end sections extending from the main body sections and defining beam leads. The main body sections are formed on the substrate with the end sections extending from the main body sections past an edge of the substrate. The first side of the substrate faces the container such that the main body sections are positioned between the substrate and the container. A protective overcoat material is applied to the backside of the main body sections so as to provide corrosion protection by preventing ink from contacting those sections. The extending end sections of the traces are attached to the bond pads via the conventional tape automated bonding (TAB) bonding process. Preferably, the bonding process is performed before either the printhead or the flexible circuit is secured to the container.

Reliability of tape automated bonding of flexible circuits is a concern. The choice of metallurgy and geometry of the traces as well as the bond pads are important in forming a reliable bond. In addition, the tape automated bonding parameters of force, time, and thermosonic energy and scrubbing direction are equally important. In the case of TAB circuit assemblies for inkjet applications, the TAB circuit provides the electrical interconnection between the printer and the printhead chip. The trace end sections of the TAB circuit are in constant contact with ink and moisture during printing and maintenance wiping. In this especially corrosive environment, it is important to minimize corrosion and dendridic growth between the TAB circuit trace end sections to ensure reliability of the printhead.

In the case of inkjet TAB circuit assemblies of Lexmark International Inc. all established products are considered “East-West” bonding configuration. This means the TAB circuit trace end sections connect to the bond pads on the East and West sides of the printhead chip. All the TAB tools are configured so the thermosonic scrubbing energy is directed in the East-West direction as well. In this configuration bond pull values are very robust. Newer products have adopted the “North-South” bonding configuration where the TAB circuit trace end sections connect to bond pads on the North and South ends of the printhead chip, while the thermosonic scrubbing energy still must be directed in the East-West direction due to tooling constraints. TAB evaluations have shown that with all circuit and chip metallurgy and geometry remaining constant, rotating the thermosonic scrubbing direction from parallel to perpendicular to the trace end sections can cause reduction of 30% or more in bond pull strength such that bonding pull values then do not always meet the process capability guidelines established for tape automated bonding.

Thus, there is still a need for an innovation that will compensate for the situation where the orientation of the thermosonic scrubbing energy is perpendicular to the direction of the trace end sections that extend to the bond pad on the printhead chip and the orientation cannot be rotated easily due to tooling constraints.

### SUMMARY OF THE INVENTION

The present invention meets some or all of the foregoing described needs by providing an innovation that creates a more robust interconnect for a situation where the thermosonic scrubbing energy is perpendicular to the direction of the trace end sections that extend to the bond pad on the chip. With such innovation the reliability of tape automated bonding of flexible circuits is improved and enhanced. The innovation proposes to create a wider end portion of the trace end section, that is, only the area where it is bonded to the chip. The provision of a larger and more stable bonding platform has provided the opportunity to reduce Au thickness back to earlier levels at significant cost savings from where Au thickness had been increased at significant increase in cost in a recent effort to increase the process capability for North-South bonding. Furthermore, the innovation of a wider end portion of the trace end section only in the bond pad area avoids adoption of a superficially attractive, but in actuality less practical, solution of creating wider overall leads or trace end sections in order to create more area and a more stable platform for scrubbing. The negative side effect of wider overall trace end sections is that they would now be closer together which would accelerate electrical shorting of traces due to dendrite growth during service of the device. Since inkjet TAB circuit assemblies are very susceptible to corrosion and dendrite growth, this is not a practical solution. Overall widening of the trace end sections would only accelerate a failure mode caused by dendrite growth between traces.

Accordingly, in an aspect of the present invention, an enhanced electrically-conductive trace on a flexible tape automated bonding circuit includes a main body section supported on a substrate and an end section integrally connected with the main body section and extending in a predetermined first direction from the main body section. The end section has an end portion spaced from the main body section and attachable on a bond pad of an inkjet printhead chip. The end portion of the end section has a width greater than the width of the remainder of the end section between the end portion and the main body section as measured in a second direction transverse to the predetermined first direction.

In another aspect of the present invention, a flexible tape automated bonding circuit includes an elongated substrate and a plurality of elongated electrically-conductive traces on the substrate spaced apart from one another and extending side-by-side in a predetermined first direction. Each of the traces includes a main body section supported on the substrate and an end section integrally connected with the main body section and extending in the predetermined first direction from the main body section. The end section has an end portion spaced from the main body section and attachable on one of a plurality of bond pads of an inkjet printhead chip. The end portion of the end section has a width greater than the width of the remainder of the end section between the end portion and the main body section as measured in a second direction transverse to the predetermined first direction.

In still another aspect of the present invention, an inkjet printhead cartridge assembly includes an inkjet printhead chip having a plurality of bond pads, and a flexible tape automated bonding circuit having an elongated substrate and a plurality of elongated electrically-conductive traces on the substrate spaced apart from one another and extending side-by-side in a predetermined first direction. Each of the traces includes a main body section supported on the substrate and an end section integrally connected with the main body section and extending in the predetermined first direction from the main body section. The end section has an end portion spaced from the main body section and attached on one of the bond pads of the inkjet printhead chip. The end portion of the end section has a width greater than the width of the remainder of the end section between the end portion and the main body section as measured in a second direction transverse to the predetermined first direction.

### BRIEF DESCRIPTION OF THE DRAWINGS

Having thus described the invention in general terms, reference will now be made to the accompanying drawings, which are not necessarily drawn to scale, and wherein:

FIG. 1 is a simplified representation of a prior art inkjet printhead cartridge assembly having a flexible tape automated bonding circuit connected to an inkjet printhead chip of the assembly by a plurality of electrically-conductive traces on the flexible circuit.

FIG. 2 is a flow chart with accompanying schematic representations, not to scale, of a sequence of stages in a prior art process for creating the end sections of the prior art traces of FIG. 1.

FIG. 3 is a simplified representation of an inkjet printhead cartridge assembly having a flexible tape automated bonding circuit connected to an inkjet printhead chip of the assembly by a plurality of enhanced electrically-conductive traces on the flexible circuit in accordance with the present invention.

FIG. 4 is a flow chart with accompanying schematic representations, not to scale, of a sequence of stages for creating the end sections of the enhanced traces of FIG. 3.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

Referring now to FIG. 1, there is schematically represented, in a simplified form, a prior art flexible TAB circuit 10 and a printhead chip 12 of an inkjet printhead cartridge 14. The flexible TAB circuit 10 generally includes a flexible substrate 16, for example made of polyimide, and multiple closely-spaced, side-by-side, electrically-conductive traces 18 made, for example, of metal formed on the flexible substrate 16. The metal traces 18 are either electroplated on the polyimide substrate 16 or a thin sheet of metal is attached to the polyimide substrate 16 with adhesive.

The multiple traces 18 each has a main body section 20 and an end section 22 which is an extension forming an electrical lead from the main body section 20. The multiple trace end sections 22 extend from the edge 16a of the flexible substrate 16 to the printhead chip 12 to where they are electrically and mechanically connected to multiple bond pads 24 on the chip 12. The electrical traces 18 at their other ends (not shown) are connected to corresponding multiple contact pads (not shown) which, in turn, are interconnected to multiple electrical terminals (not shown) on a movable carriage (not shown) within an inkjet printer. The trace pattern is created with a photolithography process, as described below.

FIG. 2 illustrates a block diagram accompanied by schematic representations of a sequence of stages in a prior art process for creating the end sections 22 of the prior art traces 18 of FIG. 1. As per block 26, the flexible base substrate 16, such as of polyimide, is prepared on which the remaining stages of the process are carried out Next, as per block 28, the substrate 16 is coated with a layer 30 of a negative resist material. Then, as per block 32, a mask 34 to pattern the end sections 22 of the traces 16 is applied on the negative resist layer 30 and thereafter the negative resist layer 30 is exposed through the mask 34 with high-intensity ultraviolet (UV) light. Next, as per block 36, a developer is applied removing the mask 34 and the material of the negative resist layer 30 under the mask 34. The negative resist material that was exposed to the UV light remains on the substrate 16. Following next, as per block 38, the end sections 22 of the traces 18 are electroplated on the substrate 16 within the gaps 40 left in the layer 30 of the negative resist material. Finally, as per block 42, the negative resist material is stripped away, leaving the metal trace end sections 22.

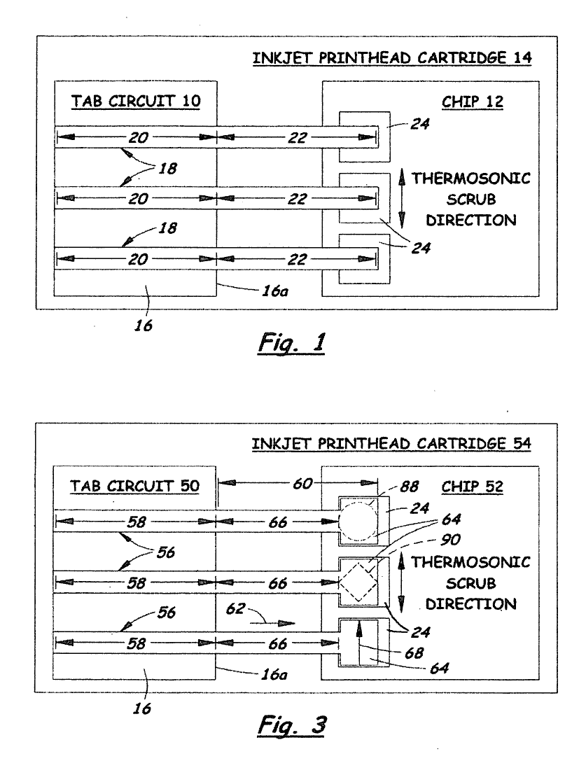

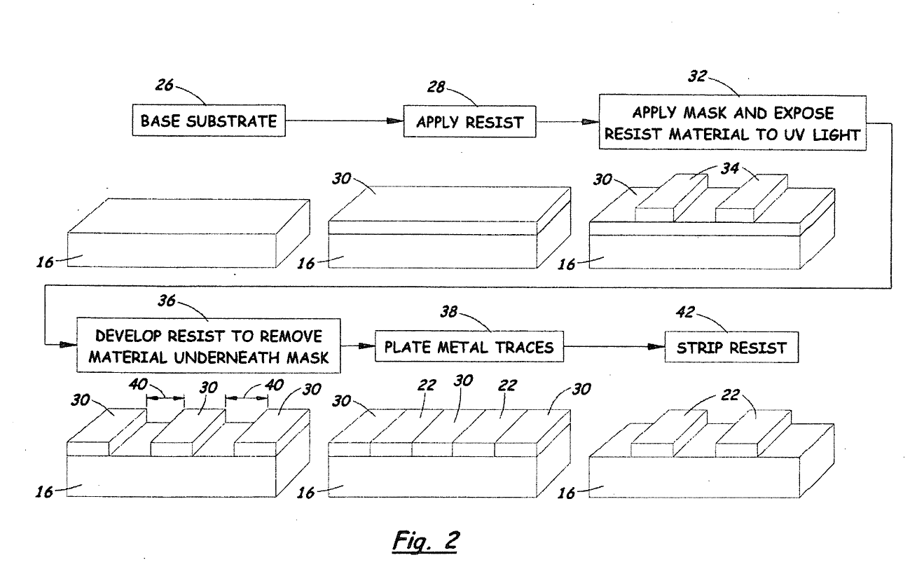

Turning now to FIG. 3, there is schematically represented, in a simplified form, a flexible TAB circuit 50 and a printhead chip 52 of an inkjet printhead cartridge 54 wherein the circuit 50 contains enhanced metal traces 56 in accordance with one embodiment of the present invention. Each metal trace 56 has a main body section 58 and an end section 60 integrally connected to and extending from the main body section 58 in a predetermined first direction as indicated by arrow 62. The end section 60 of the trace 56 has been enhanced by the provision of a wider end portion 64 thereon in the area where it is bonded to the chip 52. The end portion 64 is attached to one of the bond pads 24 on the inkjet printhead chip 12 and spaced from the main body section 58 by an interconnect section 66 of the end section 60. The end portion 64 having a width greater than the width of the remainder of end section 60, that is, greater than the width of the interconnect portion 66 spanning between the end portion 64 and the main body section 58, as measured in a second direction, as indicated by arrow 68, that is transverse to the predetermined first direction 62. The interconnect portion 66 extends from the main body section 58 past the edge 16a of the substrate 16 and is not supported by the substrate 16. Although shown as square-shaped in FIG. 3, the end portion 64 can also be other shapes, such as, for example, circular-shaped or diamond-shaped.

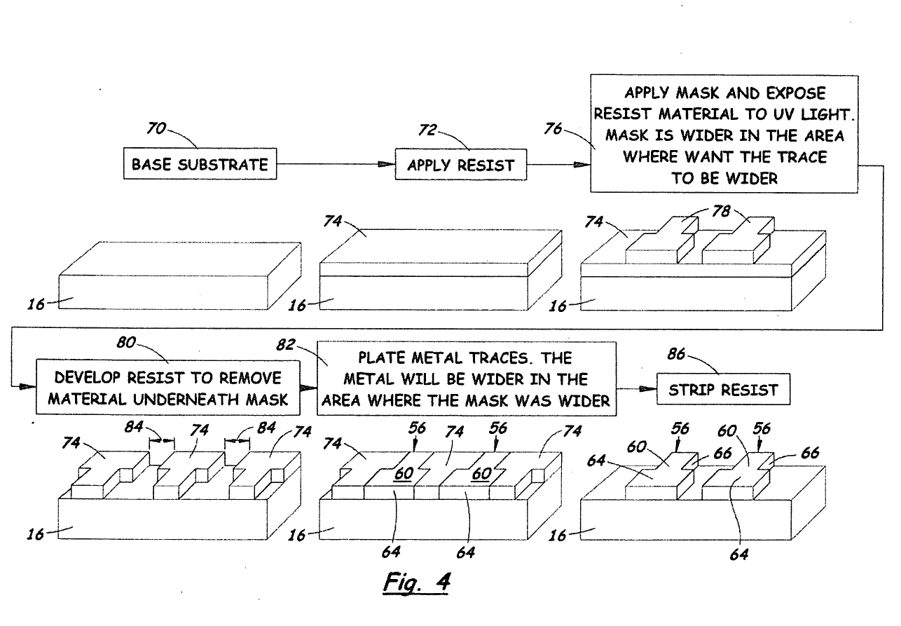

FIG. 4 illustrates a block diagram accompanied by schematic representations of a sequence of stages in a process for creating the enhanced end sections 60 of the traces 56 of FIG. 3. As per block 70, the flexible base substrate 16, such as of polyimide, is prepared on which the remaining stages of the process are carried out. Next, as per block 72, the substrate 16 is coated with a layer 74 of a negative resist material. Then, as per block 76, a mask 78 to pattern the enhanced end sections 60 of the traces 56 is applied on the negative resist layer 74 and thereafter the negative resist layer 74 is exposed through the mask 78 with high-intensity ultraviolet (UV) light. Next, as per block 80, a developer is applied removing the mask 78 and the material of the negative resist layer 74 under the mask 78. The negative resist material that was exposed to the UV light remains on the substrate 16. Following next, as per block 82, the end sections 60 of the traces 56 are electroplated on the substrate 16 within the gaps 84 left in the layer 74 of the negative resist material. Finally, as per block 86, the negative resist material is stripped away, leaving the enhanced metal trace end sections 60 with the end portions 64 wider than the interconnect portions 66.

In summary, the present invention creates a wider end portion 64 for the end section 60 of the trace 56 only in the area where it is bonded to the chip 12, in other words, on the bond pad 24. This is done easily with a photolithography mask change, as see in FIG. 4 compared to FIG. 2, to create wider trace end portions 64 only in the area of the bond pads 24 while the remaining or interconnect portions 66 of the traces 56 would be left at their current widths, as seen in FIG. 3. Also, FIG. 3 shows a square shape defined in the bond pad area; however, other shapes, such as circular or diamond, could also be used, as seen in dashed outline forms 88, 90. This would create the necessary metal area to ensure better thermosonic scrubbing while not affecting the distance between the traces 56 where they are most susceptible to dendrite growth and corrosion. Creating increased width traces 56 in the TAB area has the potential to provide a more robust TAB process while saving money on thicker Au plating of traces.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. An enhanced electrically-conductive trace on a flexible tape automated bonding circuit, comprising:
a main body section supported on a substrate; and
an end section integrally connected with said main body section and extending in a predetermined first direction from said main body section, said end section having an end portion spaced from said main body section and attachable on a bond pad of an inkjet printhead chip, said end portion of said end section having a width greater than the width of the remainder of said end section between said end portion and said main body section as measured in a second direction transverse to said predetermined first direction.

2. The trace of claim 1 wherein said remainder of said end section is an interconnect portion spanning between said main body section and said end portion of said end section.

3. The trace of claim 2 wherein said interconnect portion of said end section extends from said main body section past an edge of said substrate.

4. The trace of claim 2 wherein said interconnect portion is not supported by said substrate.

5. The trace of claim 2 wherein said width of said end portion is greater than that of said interconnect portion.

6. The trace of claim 1 wherein said end portion of said end section is square shaped.

7. The trace of claim 1 wherein said end portion of said end section is circular shaped and said width is the diameter across said circular-shaped end portion.

8. The trace of claim 1 wherein said end portion of said end section is diamond shaped and said width is a maximum dimension across said diamond-shaped end portion.

9. A flexible tape automated bonding circuit, comprising:
an elongated substrate; and
a plurality of elongated electrically-conductive traces on said substrate spaced apart from one another and extending side-by-side in a predetermined first direction;
wherein each of said traces includes
a main body section supported on said substrate, and
an end section integrally connected with said main body section and extending in said predetermined first direction from said main body section, said end section having an end portion spaced from said main body section and attachable on one of a plurality of bond pads of an inkjet printhead chip, said end portion of said end section having a width greater than the width of the remainder of said end section between said end portion and said main body section as measured in a second direction transverse to said predetermined first direction.

10. The circuit of claim 9 wherein said remainder of said end section is an interconnect portion spanning between said main body section and said end portion of said end section.

11. The circuit of claim 10 wherein said interconnect portion of said end section extends from said main body section past an edge of said substrate.

12. The circuit of claim 10 wherein said interconnect portion is not supported by said substrate.

13. The circuit of claim 10 wherein said width of said end portion is greater than that of said interconnect portion.

14. The circuit of claim 9 wherein said end portion of said end section is square shaped.

15. The circuit of claim 9 wherein said end portion of said end section is circular shaped and said width is the diameter across said circular-shaped end portion.

16. The circuit of claim 9 wherein said end portion of said end section is diamond shaped and said width is a maximum dimension across said diamond-shaped end portion.

17. An inkjet printhead cartridge assembly, comprising:
an inkjet printhead chip having a plurality of bond pads; and
a flexible tape automated bonding circuit having an elongated substrate and a plurality of elongated electrically-conductive traces on said substrate spaced apart from one another and extending side-by-side in a predetermined first direction, wherein each of said traces includes
a main body section supported on said substrate, and
an end section integrally connected with said main body section and extending in said predetermined first direction from said main body section, said end section having an end portion spaced from said main body section and attached on one of said bond pads of said inkjet printhead chip, said end portion of said end section having a width greater than the width of the remainder of said end section between said end portion and said main body section as measured in a second direction transverse to said predetermined first direction.

18. The assembly of claim 17 wherein said remainder of said end section is an interconnect portion spanning between said main body section and said end portion of said end section.

19. The assembly of claim 17 wherein said interconnect portion of said end section extends from said main body section past an edge of said substrate and is not supported by said substrate.

20. The assembly of claim 17 wherein said end section is one of square, circular or diamond shaped.
